(19) United States
(12) Patent Application Publication
(10) Pub. No.: US 2004/0119249 A1
(43) Pub. Date: Jun. 24, 2004

(54) Chuck

(76) Inventor: Chun-Chih Chen, Changhua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/321,381

(22) Filed: Dec. 18, 2002

(51) Int. Cl. B23B 31/175

(52) U.S. Cl. 279/119

(57) ABSTRACT

A chuck for gripping a workpiece in a machine includes a chuck body, jaw assemblies and an adapter assembly. A through hole is defined axially in the chuck body. The jaw assemblies are radially and moveably mounted in the chuck body and pivoted by the adapter assembly. The adapter assembly is moveably mounted in the through hole in the chuck body and has a coupling member that is adapted to attach to a draw rod of the machine. The adapter assembly will axially move as the draw rod moves and drive the jaw assemblies inward to grip a workpiece. The coupling member is replaceable and attaches to the draw rod so the chuck is quickly changed without changing the draw rod of the machine.

### BACKGROUND OF THE INVENTION

1. Field of the Invention

The present invention relates to a chuck, and more particularly to a quick-change chuck that has a long jaw stroke for gripping a workpiece in a machine.

2. Description of Related Art

Machines often use a chuck such as a three-jaw chuck or self-centering chuck in a lathe to grip a workpiece on the machine. Chucks available today are hydraulic or pneumatic to provide a holding pressure. Lathes are used for many applications in machining and use chucks to hold workpieces in exact positions. Typical of such chucks is the three-jaw chuck that is coupled with a draw rod of the machine.

Today, sizes of both the chuck and the draw rod are standard. However, the shape of the workpiece is not standard. To reduce equipment cost, manufactures often need to change the chuck to accommodate the shape of the workpiece. For example, the standard lathe uses a standard chuck with a standard dimension and standard specifications. One of the standard specifications, called jaw stroke, is used to estimate how large a workpiece the chuck can grip. A long jaw stroke means the chuck can grip a big outer diameter of the workpiece.

To change the chuck quickly can save time and money when this change is necessary. With reference to FIGS. 3 and 4, a conventional method for attaching the chuck to the draw rod of the machine is by means of threads. The chuck comprises a body (90), a jaw assembly (92) and a sliding member (93). The body (90) has a central hole (900), a front end (901) and a rear end (902). The rear end (902) of the body (90) faces the draw rod (80) of the machine (not shown). The central hole (900) is defined through the body (90) from the rear end (902) to the front end (901).

The jaw assembly (92) includes three jaws (921) that are radially and slidably mounted in the front end (901) of the body (90). The sliding member (93) is slidably mounted in the central hole (900) of the body (90) and drives the jaws (921) inward to grip and hold the workpiece as the sliding member (93) moves axially. The sliding member (93) has a coupling end (not numbered) with an external thread (931), and the coupling end attaches to the draw rod (80) of the machine. The draw rod (80) has an internal thread (not numbered) that is used to screw onto the external thread (931) of the sliding member (93). Therefor, the chuck is attached to the draw rod (80) by means of the treads.

However, the conventional chuck has some shortcomings. The conventional chuck must to be replaced with a chuck that has a long jaw stroke at least large as the outer diameter of the workpiece. The external thread (931) of the sliding member (93) of the standard chuck is different from the chuck with the long jaw stroke, but the draw rod (80) in the machine is the same. If the operator wants to replace the standard chuck with a chuck that has a long jaw stroke, the draw rod (80) in the machine needs to be changed to accommodate the thread in the chuck, too. Changing the draw rod (80) in the machine is not easy and requires a considerable amount of time.

To overcome the shortcomings, the present invention provides an improved chuck to mitigate or obviate the aforementioned problems.

### SUMMARY OF THE INVENTION

The main objective of the invention is to provide a quick-change chuck for gripping a workpiece in machines.

Another objective of the invention is to reduce the time to change the chuck in machines. Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side plan view of a chuck in accordance with the present invention;

FIG. 2 is an exploded perspective view in section of the chuck in FIG. 1;

FIG. 3 is a front plan view of a three-jaw chuck in accordance with the prior art; and

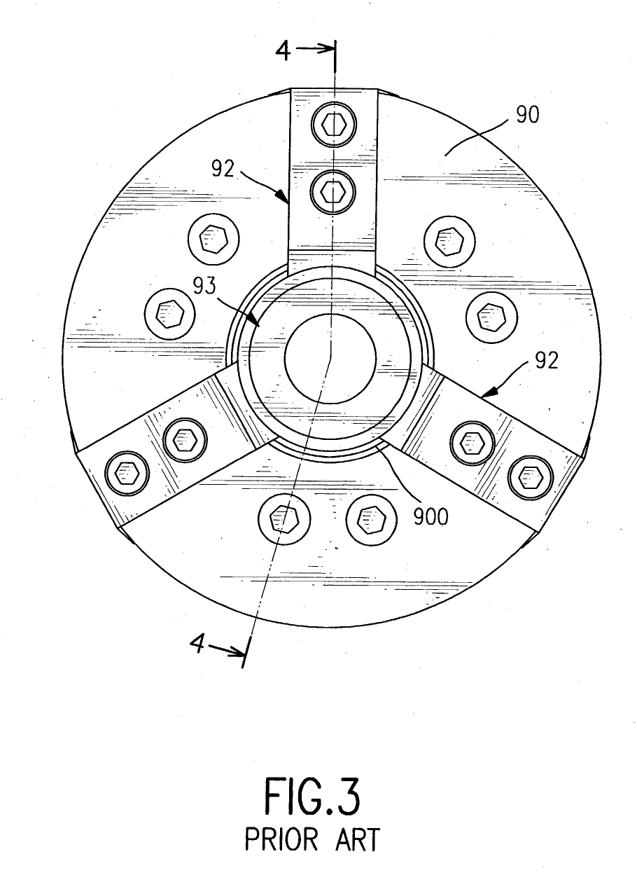

FIG. 4 is a cross sectional side plan view of the three-jaw chuck along line 4-4 in FIG. 3.

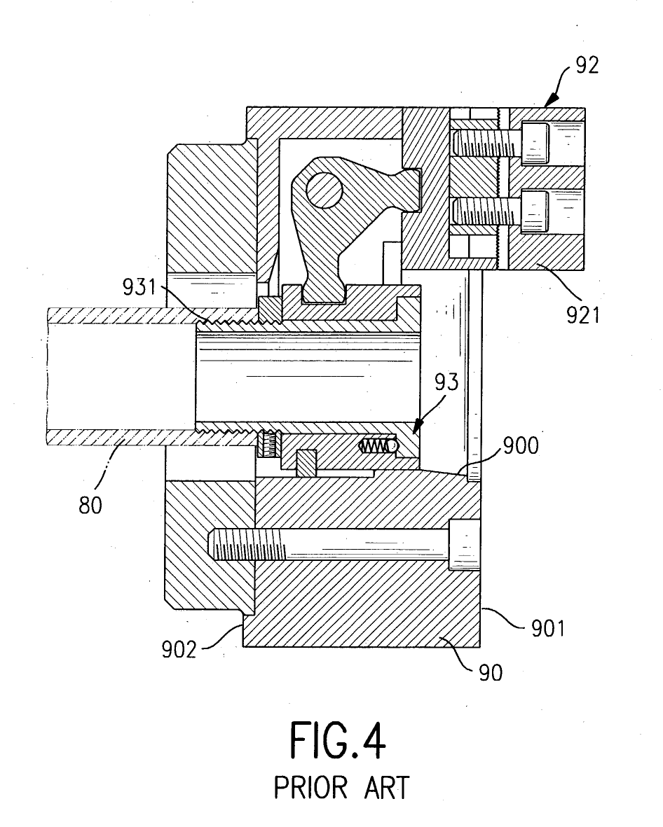

### DETAILED DESCRIPTION OF PREFERRED EMBODIMENT

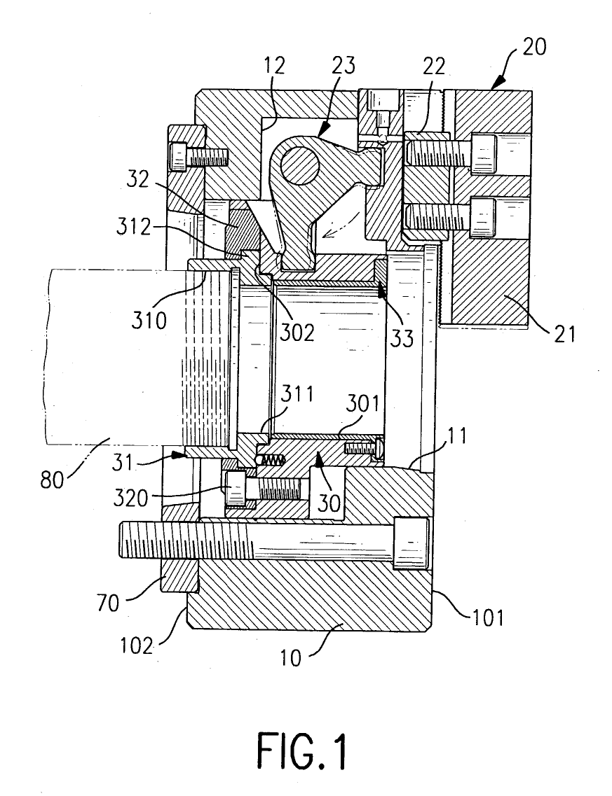

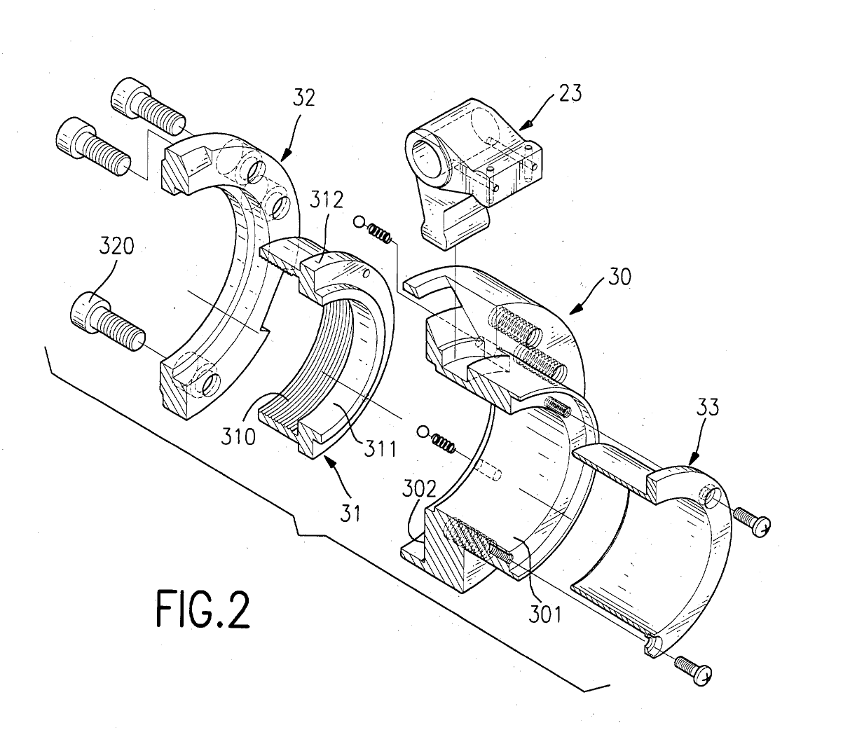

A chuck is adapted to attach to the shaft of a machine, such as a lathe, and is used to grip a workpiece. With reference to FIGS. 1 and 2, a chuck in accordance with the present invention comprises a chuck body (10), jaw assemblies (20), an adapter assembly and a ring (70). In this embodiment, the chuck includes three jaw assemblies, although these skilled in the art will recognize that two or more may be used.

The chuck body (10) has an axis (not numbered), a front end (101) and a rear end (102). A through hole (11) is defined axially through the chuck body (10) from the front end (101) to the rear end (102). Three radial slots (not numbered) are defined radially in the front end of the chuck body (10). Cavities (12) are defined in the chuck body (10) and respectively communicate with each radial slot and the through hole (11) in the chuck body (10). Each jaw assembly (20) includes a jaw (21), a jaw guide (22) and a lever arm (23). The jaw guides (22) are mounted slidably in the respective radial slots in the chuck body (10), and the jaws (21) are attached to the jaw guide (22) to grip the workpiece. A lever arm (23) is pivotally mounted in each cavity (12) in the chuck body (10) and is coupled to the jaw guide (22) to drive it inward to hold the workpiece.

The jaw assemblies are attached, via the adapter assembly, to an axial draw rod (80) of the machine. Axially movement of the draw rod (80) is converted to simultaneous reciprocal movement of the jaw assemblies (20) to provide a self-centering movement to grip the workpiece. The adapter assembly includes a slide body (30), a coupling member (31), a positioning ring (32) and a sleeve (33). The slide body (30) is moveably mounted in the through hole (11) in the chuck body (10) and pivots the lever arm (23) as the slide body (30) moves axially. The slide body (30) has a stepped central hole (301) that is defined axially through the slide body (30). The stepped central hole (301) has a shoulder (302) near the rear end (102) of the chuck body (10). The coupling member (31) is attached to the shoulder (302) of the stepped central hole (301) in the slide body (30). The coupling member (31) has an outside surface (not numbered), an internal thread (310), a through hole (311) and a flange (312). The through hole (311) has a fixed diameter and is axially defined through the coupling member (31), and the internal thread (310) is formed in the through hole (311) of the coupling member (31) near the rear end (102) of the chuck body (10). The flange (312) is formed around outside surface of the coupling member (31) and abuts the shoulder (302) in the stepped hole (301). The positioning ring (32) is attached to the shoulder (302) in the stepped hole (301) and clamps the flange (312) of the coupling member (31) by means of fasteners (320). Such fasteners (320) are typically bolts so the coupling member (31) is held in position on the slide body (30).

To prevent the slide body (30) from sliding out of the through hole (11) in the chuck body (10), the ring (70) is attached to the rear end (102) of the chuck body (10) by means of bolts. Normally, the draw rod (80) of the machine has an external threaded end (not numbered) that screws into the internal tread (310) in the through hole (311) of the coupling member (31). The draw rod (80) has a fixed outer diameter. The coupling member (31) is screwed firmly onto the threaded end of the draw rod (80) and moved by the draw rod (80) as the draw rod (80) moves axially. The sleeve (33) is mounted in the stepped central hole (301) in the slide body (30) near the front end (101) of the chuck body (10).

The diameter of the through hole (311) in the coupling member (31) accommodated the outer diameter of the threaded end of the draw rod (80) so the draw rod (80) of the machine does not need to be replaced when the chuck is changed. Depending on the outer diameter of the threaded end of the draw rod (80), the operator only needs to remove the positioning ring (32), replace the coupling member (31) with a suitable coupling member (31) and reattach the positioning ring (32) to clamp the coupling member (31) in place. This is much easier than replacing the draw rod (80) in the machine.

Attaching the chuck as described and the draw rod (80) is simple and easy. The chuck is quick-change and compatible with various types of machine in machining. Less time is required to change the chuck, and chuck equipment cost is reduced for operators.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chuck for gripping a workpiece, and the chuck comprising:
a chuck body with an axis, a front end and a rear end, the chuck body having
a through hole axially defined in the chuck body from the front end to the rear end of the chuck body;
at least two radial slots radially defined in the front end of the chuck body; and
a cavity defined in the chuck body to communicate with each respective one of the at least two radial slots and the through hole of the chuck body;
a jaw assembly corresponding to each of the at least two radial slots, the jaw assembly comprising
a jaw guide moveably mounted in the corresponding respective one of the at least two radial slots of the chuck body;
a jaw attached to the jaw guide; and
a lever arm pivotally mounted in the cavity in the chuck body and attached to the jaw guide; and
an adapter assembly comprising
a slide body slidably mounted in the through hole in the chuck body and pivoting the lever arms, and the slide body having a stepped central hole with a shoulder defined axially in the stepped central hole;
a coupling member attached to the slide body and abutting the shoulder Of the stepped central hole of the slide body and the coupling member having
an outer surface;
a through hole defined axially through the coupling member;
an internal thread formed in the through hole of the coupling member near the rear end of the chuck body; and
a flange formed on the outer surface and abutting the shoulder of the stepped central hole; and
a positioning ring attached to the shoulder of the stepped central hole of the slide body and clamping the coupling member;
wherein the coupling member is adapted to attach to a draw rod in a machine with the internal thread.

2. The chuck as claimed in claim 1 further comprising a sleeve attached in the stepped central hole of the slide body near the front end of the chuck body.

3. The chuck as claimed in claim 2, wherein the positioning ring clamps the coupling member by means of fasteners.

4. The chuck as claimed in claim 3, wherein the fasteners are bolts.

5. The chuck as claimed in claim 1 further comprising a ring attached to the rear end of the chuck body.

6. The chuck as claimed in claim 3 further comprising a ring attached to the rear end of the chuck body.
